(19) United States
(12) Patent Application Publication
(10) Pub. No.: US 2010/0302264 A1
(43) Pub. Date: Dec. 2, 2010

(54) Image Processing Device and Image Processing Method

(75) Inventors: Hiroyuki Segawa, Kanagawa (JP); Akio Ohba, Kanagawa (JP)

Correspondence Address: GIBSON & DERNIER LLP, 900 ROUTE 9 NORTH, SUITE 504, WOODBRIDGE, NJ, 07095, US

(73) Assignee: SONY COMPUTER ENTERTAINMENT INC., Tokyo (JP)

(21) Appl. No.: 12/787,489

(22) Filed: May 26, 2010

(30) Foreign Application Priority Data
May 28, 2009 (JP) 2009-129561

(51) Int. Cl. G09G 5/36; G06T 1/60

(52) U.S. Cl. 345/545; 345/530

(57) ABSTRACT

A display timing setting unit determines the timing of rendering an image by raster scanning. A pixel reading unit reads a pixel according to timing information output from the display timing setting unit. An area of interest information input unit enters information for identifying an arbitrary area of interest within an image. An area of interest identifying unit determines whether the pixel is included in the area of interest based on the timing information output by the display timing setting unit. A finite-bit generation unit generates a finite bit series by subjecting information on the pixel to mapping transformation when the pixel is included in the area of interest.

### BACKGROUND OF THE INVENTION

1. Field of the Invention

The present invention relates to an image processing device and an image processing method adapted to process an image output from, for example, a computer.

2. Description of the Related Art

Computer networks are now available for ordinary household. It is common to connect computers in the rooms using wireless LAN or share a printer. There is also a rising need for displaying still images and moving images stored in a computer using a game device or a television (TV) system in a living room in hassle free manner so that the family can enjoy viewing pictures taken by a digital camera or images downloaded from the Internet.

In this background, game devices and TV systems are required to connect to a computer network and to display a computer screen on a display of a game device or a TV system connected to the network instead of a PC monitor directed connected to the computer.

Service called “remote desktop” is available whereby the desktop screen of a remote computer is virtually displayed on the screen of another computer connected to the network. An operation on the virtual desktop screen is transmitted to the remote computer via the network using a specific protocol so as to remote control the remote computer.

[patent document No. 1] Published U.S. Patent Application 2007/0202956

In order to display the desktop screen of a remote computer on the screen of another computer or TV for remote control on the desktop screen, the desktop screen should be transmitted to the computer. According to one known technology, the desktop screen is divided into multiple rectangular areas so that only the area in which a change occurs is transmitted. However, the related-art technology will transmit the desktop screen to another computer even if only the position of a specific window is changed while the content in the window remains unchanged. Time and resources required for transmission will be wasted if the display content of a specific window counts and the display position does not count.

### SUMMARY OF THE INVENTION

The present invention addresses the problem and a purpose thereof is to provide a technology of detecting a change in an arbitrary area of interest in the data displayed on the screen of, for example, a computer.

An image processing device according to at least one embodiment of the present invention addressing the above challenge comprises: a display timing setting unit adapted to determine the timing of rendering an image by raster scanning; a pixel reading unit adapted to read a pixel according to timing information output from the display timing setting unit; an area of interest information input unit adapted to enter information for identifying an arbitrary area of interest within an image; an area of interest identifying unit adapted to determine whether the pixel is included in the area of interest based on the timing information output by the display timing setting unit; and a finite-bit generation unit adapted to generate a finite bit series by subjecting information on the pixel to mapping transformation when the pixel is included in the area of interest.

An image processing device according another embodiment comprises: a display buffer adapted to store image information; a plurality of image processing units adapted to transform the image information and connected in series; a finite-bit generation unit adapted to generate a first finite bit series by subjecting an image actually output by each image processing unit to mapping transformation; and a finite-bit comparison unit adapted to verify the operation of each image processing unit by comparing a second finite bit series obtained by subjecting an image that should be output from each image processing unit to mapping transformation with the first finite bit series.

Still another embodiment of the present invention relates to an image processing method. The method comprises: determining the timing of rendering an image by raster scanning; reading a pixel according to timing information output from a display timing setting unit; entering information for identifying an arbitrary area of interest within an image; determining whether the pixel is included in the area of interest based on the timing information output by the display timing setting unit; and generating a finite bit series by subjecting information on the pixel to mapping transformation when the pixel is included in the area of interest.

Yet another embodiment of the present invention relates to a computer program that generates a finite bit series by subjecting an area of interest in an image to mapping transformation. The program comprises: a module adapted to determine the timing of rendering an image by raster scanning; a module adapted to read a pixel according to timing information output from the display timing setting unit; a module adapted to enter information for identifying an arbitrary area of interest within an image; a module adapted to determine whether the pixel is included in the area of interest based on the timing information output by the display timing setting unit; and a module adapted to generate a finite bit series by subjecting information on the pixel to mapping transformation when the pixel is included in the area of interest.

Optional combinations of the aforementioned constituting elements, and implementations of the invention in the form of methods, apparatuses, systems, computer programs, data structures, and recording mediums may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the overall configuration of a screen output system according to an embodiment of the present invention;

FIG. 2 shows an example of the configuration of the display timing setting unit of FIG. 1;

FIG. 3 shows another example of the configuration of the display timing setting unit of FIG. 1;

FIG. 4 shows an example of the configuration of the area of interest identifying unit of FIG. 1;

FIG. 5 shows a display area divided into five rectangular areas such that the horizontal direction is aligned with the longitudinal direction as well as showing the non-display area;

FIG. 6 shows the configuration of the line direction determination unit of FIG. 4;

FIG. 7 shows the relation between Hsync, Vsync, and the display area for the image;

FIG. 8 shows another example of the configuration of the area of interest identifying unit of FIG. 1;

FIG. 9 shows the configuration of the line counter of FIG. 8;

FIG. 10 shows the configuration of the line count comparison unit of FIG. 8;

FIG. 11 shows another example of the configuration of the area of interest identifying unit of FIG. 1;

FIG. 12 shows the configuration of the line counter of FIG. 11;

FIG. 13 shows the configuration of the line count comparison unit of FIG. 11;

FIG. 14 shows how two areas of interest, i.e., the first area and the second area, are established in the display area;

FIG. 15 shows the configuration of the area of interest determination unit of FIG. 11;

FIG. 16 shows the configuration of the inverted area computing unit of FIG. 15;

FIG. 17 shows how an area of interest is configured as an area derived from excluding a rectangular area within the display area;

FIG. 18 shows the configuration of the mapping transformation unit of FIG. 1;

FIG. 19 shows windows displayed in the display area before and after a change in the display position;

FIG. 20 shows how information is subject to mapping transformation preceding and following image processing in each image processing unit as the information is processed through multiple image processing units provided between a display buffer and an image output unit;

FIG. 21 shows another example in which information is subject to mapping transformation preceding and following image processing in each image processing unit as the information is processed through multiple image processing units provided between a display buffer and an image output unit; and

FIG. 22 shows yet another example in which information is subject to mapping transformation preceding and following image processing in each image processing unit as the information is processed through multiple image processing units provided between a display buffer and an image output unit.

### DETAILED DESCRIPTION OF THE INVENTION

The invention will now be described by reference to the preferred embodiments. This does not intend to limit the scope of the present invention, but to exemplify the invention.

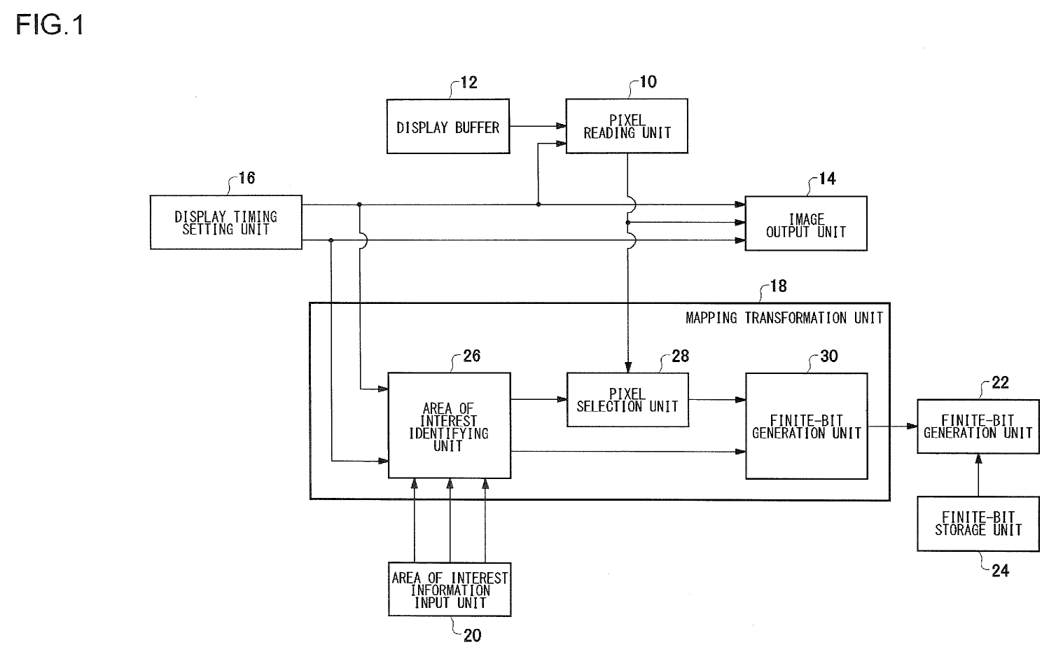

FIG. 1 shows the overall configuration of a screen output system according to an embodiment of the present invention. A pixel reading unit 10 reads pixel data from a display buffer 12 based on a pixel clock (frequency of pixels drawn) acquired from a display timing setting unit 16 and outputs the data to an image output unit 14. The image output unit 14 acquires the pixel clock and Hsync (horizontal synchronization signal) from the display timing setting unit 16 and outputs the pixel acquired from the pixel reading unit 10 to a display device such as a monitor (not shown).

A mapping transformation unit 18 receives, from an area of interest information input unit 20, information on an area of interest subject to mapping transformation. The transformation unit 18 identifies a pixel included in the area of interest by referring to the pixel clock and Hsync from the display timing setting unit 16 and generates a finite number of bits based on the pixel data. The finite number of bits thus generated are transmitted to a finite-bit comparison unit 22 and are compared with the finite number of bits stored in a finite-bit storage unit 24.

The information stored in the finite-bit storage unit 24 is a finite number of bits obtained by subjecting an image that should normally be displayed in the area of interest to mapping transformation. Whether the pixel reading unit 10 and the display timing setting unit 16 are operated properly can be verified by examining whether the data as compared by finite-bit comparison unit 22 match.

Another example of the information stored in the finite-bit storage unit 24 is a finite number of bits obtained by subjecting an area of interest in a past frame to mapping transformation. Whether a change occurs in the area of interest from the past image in the frame can be identified by examining whether the finite-bit comparison unit 22 determines that the data as compared match. The term “past frame” refers to, for example, an image that goes back one frame.

The mapping transformation unit 18 includes an area of interest identifying unit 26, a pixel selection unit 28, and a finite-bit generation unit 30. The area of interest identifying unit 26 receives, from the area of interest information input unit 20, information on an area of interest subject to mapping transformation. The unit 26 identifies the area of interest by referring to the pixel clock and Hsync from the display timing setting unit 16 and generates information indicating whether the pixel is included in the area of interest. The pixel selection unit 28 refers to the output from the area of interest identifying unit 26 and, when the pixel is included in the area of interest, outputs the pixel data to the finite-bit generation unit 30. The finite-bit generation unit 30 receives an area of interest identification number from the area of interest identifying unit 26 and generates a finite number of bits for each area of interest based on the pixel data acquired from the pixel data selection unit 28.

The term “mapping transformation” refers to mapping from a large volume of data such as pixel data for an image into a finite number of bits. Any mapping scheme capable of generating a hash value (e.g., cyclic redundancy check or message digest algorithm 5 (MD5)) may be used.

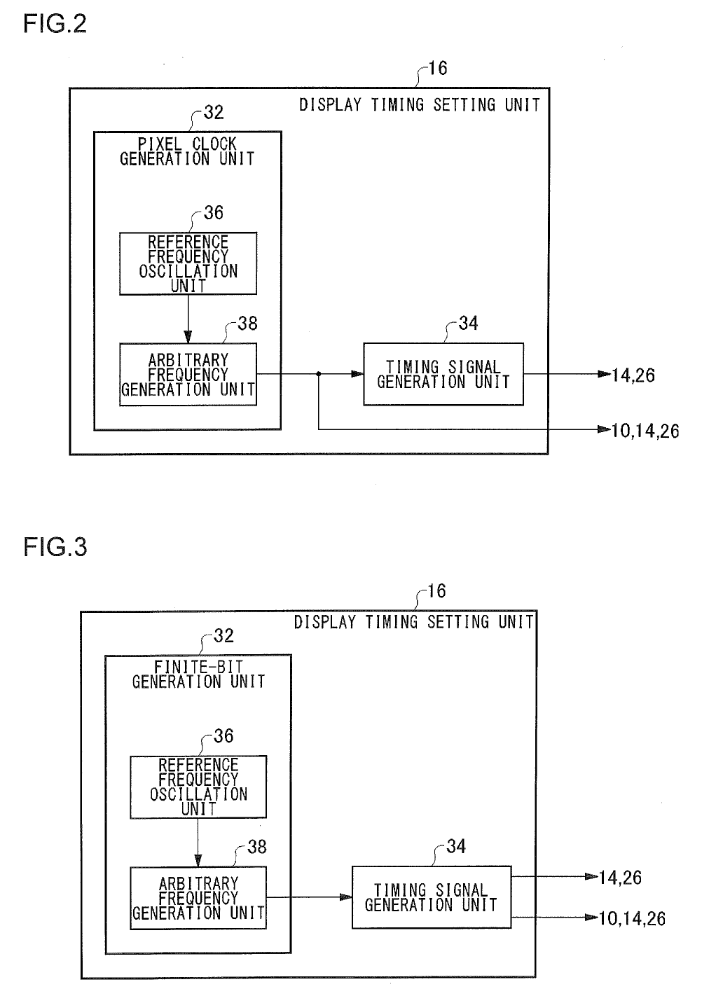

FIG. 2 shows an example of the internal configuration of the display timing setting unit 16. The display timing setting unit 16 includes a pixel clock generation unit 32 and a timing signal generation unit 34. The pixel clock generation unit 32 further includes a reference frequency oscillation unit 36 and an arbitrary frequency generation unit 38.

The reference frequency oscillation unit 36 produces a signal of a specific frequency with high precision. For example, the unit 36 may be implemented by a crystal oscillator. The arbitrary frequency oscillation unit 38 converts the signal from the reference frequency oscillator 36 into a pixel clock signal. The unit 38 may be implemented by, for example, a PLL circuit and a frequency divider.

The timing signal generation unit 34 generates Hsync based on the pixel clock obtained by the arbitrary frequency generation unit 38. In this example, the display timing setting unit 16 diverts the pixel clock generated by the pixel clock generation unit 32 for output to an external device before transmitting the clock to the timing signal generation unit 34.

FIG. 3 shows another example of the internal configuration of the display timing setting unit 16. In this example, the pixel clock is retrieved from the timing signal generation unit 34. This can be achieved by outputting the information from the timing signal generation unit 34, which acquires the pixel clock to generate Hsync. In comparison with the case of diverting the pixel clock for output to an external device before transmitting the clock to the timing signal generation unit 34, it is ensured that the pixel signal and Hsync, which represent timing signals, are generated from the same source. Thereby, delay can be reduced advantageously.

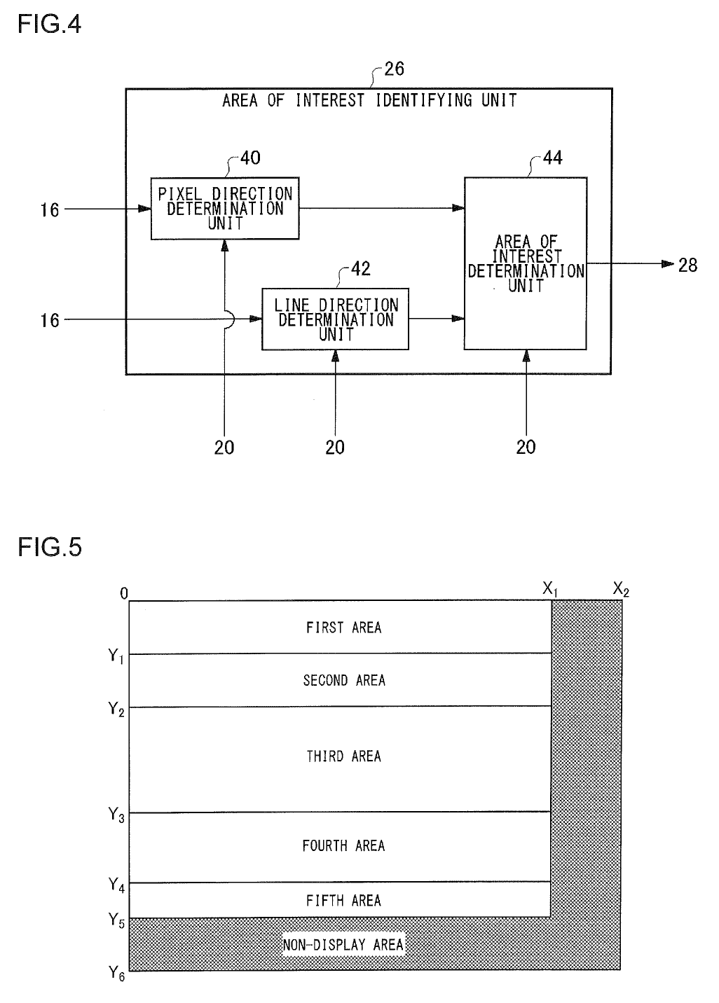

FIG. 4 shows the internal configuration of the area of interest identifying unit 26. The area of interest identifying unit 26 includes a pixel direction determination unit 40, a line direction determination unit 42, and an area of interest determination unit 44.

The pixel direction determination unit 40 and the line direction determination unit 42 each acquires positional information on the area of interest from the area of interest information input unit 20. Subsequently, the pixel direction determination unit 40 receives the pixel clock from the display timing setting unit 16 so as to determine whether the coordinate of the pixel currently read by the pixel reading unit 10 is included in the horizontal (X-axis direction) extent of the area of interest. Further, the line direction determination unit 42 receives Hsync from the display timing setting unit 16 so as to determine whether the coordinate of the pixel is included in the vertical (Y-axis direction) extent of the area of interest.

The area of interest determination unit 44 receives the information indicating whether the currently read pixel is included in the horizontal extent and in the vertical extent from the pixel direction determination unit 40 and the line direction determination unit 42, respectively. The unit 44 determines whether the pixel is included in the area of interest based on the information. In this process, the area of interest determination unit 44 receives information defining the position of the area of interest in the horizontal and vertical directions from the area of interest information input unit 20, for accurate determination in the presence of multiple areas of interest are located in the image. By referring to the identification information, the area of interest determination unit 44 can determine a proper combination of the horizontal extent and the vertical extent of the area of interest. The result of determination is transmitted to the pixel selection unit 28.

A description will now be given of the line direction determination unit 42 according to the embodiment, using a specific example.

FIG. 5 shows an example where the display area is divided into five areas, i.e., into areas 1 through 5. The display area on the screen is of a horizontal size of X1 (e.g., 1920 pixels) and a vertical size of Y5 (e.g., 1080 lines). Normally, the video signal such as that of the embodiment goes blank for a certain period of time. Referring to FIG. 5, the blanking period is defined as a period between X1 and X2 in the horizontal direction and between Y5 and Y6 in the vertical direction. For example, the size of X2 is 2200 and the size of Y6 is 1125. The area defined by removing the display area from the rectangle of a width (horizontal dimension) of Y6 and a height (vertical dimension) of X2 represents a non-display area.

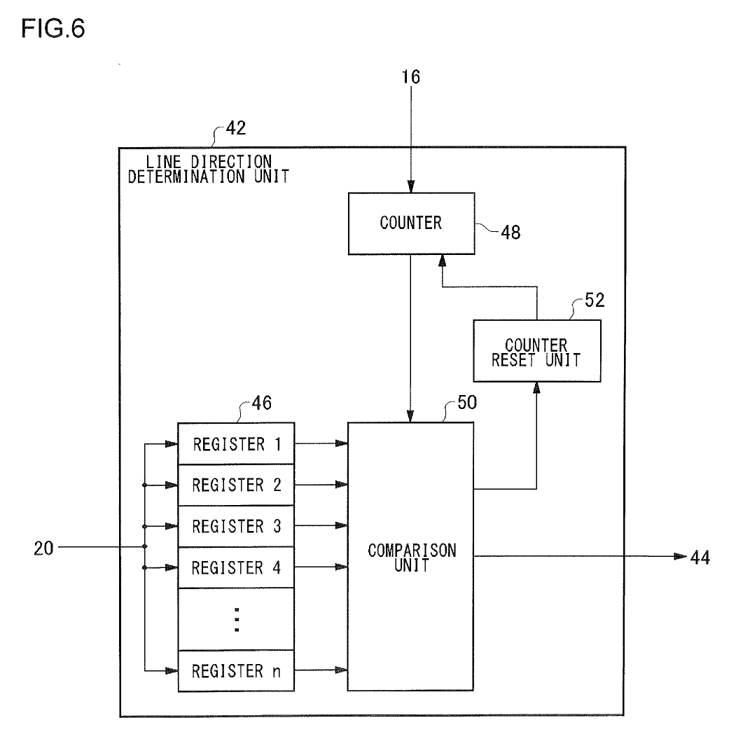

FIG. 6 shows an example of the internal configuration of the line direction determination unit 42. In this example, the line direction determination unit 42 includes a register group 46, a counter 48 for counting Hsync, a comparator 50, and a counter reset unit 52.

The register group 46 receives the vertical coordinate for defining the area of interest from the area of interest information input unit 20. For example, given that the areas of interest are five rectangular areas derived from dividing the image such that the longitudinal direction of each area is aligned with the horizontal direction of the image, the topmost area (first area) in the image is identified using Y1, the Y coordinate defining the boundary with the adjacent area (second area). Therefore, Y1 is stored in register 1. The second area is identified using Y1, the Y coordinate defining the boundary with the first area and using Y2, the Y coordinate defining the boundary with the area (third area) adjacent to the second area opposite to the first area. Therefore, Y2 is stored in register 2. Similarly, the third area is identified using Y2 and Y3, and the fourth area can be identified based on Y3 and Y4. Therefore, Y3 and Y4 are stored in register 4. The fifth area is defined as an area beyond Y4, the Y coordinate defining the boundary with the fourth area. Therefore, the fifth area is identified only by using Y4. As discussed above, four registers are needed to identify five areas. Generally, a total of n−1 registers are needed to identify a total of n areas.

The counter 48 increases the value in the counter (not shown) by one each time the counter 48 receivers Hsync from the display timing setting unit 16. The counter value indicates the Y coordinate of the position where the currently read pixel is displayed. Therefore, the area that includes the pixel is known by comparing the value with the value stored in the register group 46.

The comparison 50 receives the counter value and the value stored in the register group 46 and compares the values. More specifically, the comparison unit 50 initially compares the counter value with Y1 stored in register 1. When the counter value is smaller than Y1, the pixel is included in the first area. “1” is then output to the area of interest determination unit 44 as an identifier in the line direction. When the counter value is equal to or greater than Y1, the counter value and Y3, stored in register 2, are compared. When the counter value is smaller than Y3, the pixel is included in the second area. “2” is then output to the area of interest determination unit 44 as an identifier in the line direction.

Similar steps are repeated subsequently. When the counter value is smaller than Y3, stored in register 3, “3” is output to the area of interest determination unit 44. When the counter value N is such that N≦Y3<Y4, “4” is output. When the counter value is Y4 or greater, the pixel is included in the fifth area so that “5” is output to the area of interest determination unit 44.

In order to prevent the counter from being saturated, the counter value should be reset to “0” at an appropriate point of time. More specifically, when the counter value exceeds the coordinate (Y5) of the boundary in the vertical direction of the display area and reaches the coordinate (Y6) of the non-display area in the vertical direction, the comparison unit 50 transmits a signal to the counter reset unit 52. The counter reset unit 52 resets the counter value of the counter 48 to zero. To achieve this, it is necessary to store Y6, the coordinate defining the boundary of the non-display area in the vertical direction, in register 5 of the register group 46. Therefore, five registers are needed to identify five areas, allowing for reset of the counter. Generally, a total of at least n registers are needed to identify a total of n areas.

Reset of the counter may alternatively be achieved by using a vertical synchronization signal (Vsync). A method of resetting the counter using Vsync will be described below.

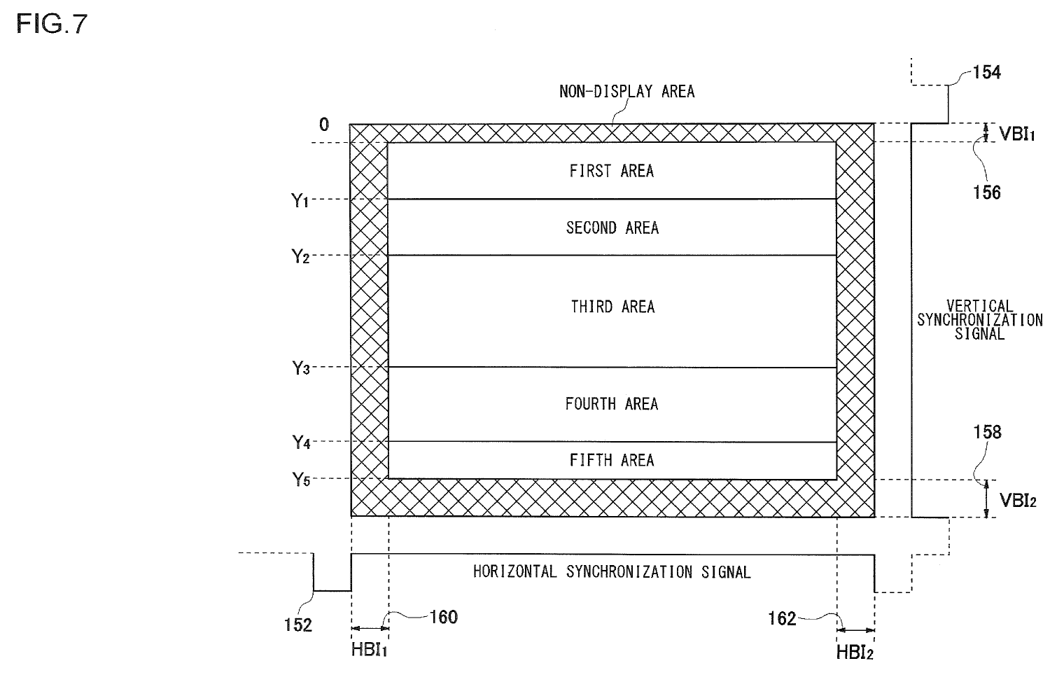

FIG. 7 is a schematic representation of the relation between Hsync 152, Vsync 154, and the display area for the image. FIG. 7 shows a case in which the non-display area extends horizontally both to the right and left of the display area and extends vertically both above and below the display area.

Vsync is used for synchronization in the vertical direction in pixel rendering by raster scanning. Therefore, the lines can be properly counted by resetting the counter value to “0” when Vsync is asserted. The non-display area above and below in the vertical direction as shown in FIG. 7 is due to a vertical blanking period 156 occurring immediately after Vsync is asserted and a vertical blanking period 158 occurring after the pixel is rendered in the display area and before next Vsync is asserted. In the presence of these blanking periods, it is necessary to store, as boundary coordinate values (Y1-Y5) of the display area in the vertical direction, the values obtained by adding an offset value equal to the number of lines VBI1 corresponding to the vertical blanking period 156 in the registers in the register group 46.

The vertical blanking period contains the number of lines VBI1 corresponding to the vertical blanking period 156 and the number of lines VBI2 corresponding to the vertical blanking period 158, and so does the horizontal blanking period contain the horizontal blanking period HBI1 160 occurring immediately after Hsync is asserted and the horizontal blanking period HBI2 162 occurring after the pixel is rendered in the display area and before next Hsync is asserted. As a result, the display area is surrounded by the non-display area as shown in FIG. 7.

When the counter is reset based on Vsync, the register for counter reset is not necessary so that at least n−1 registers need be prepared in order to identify n areas. Vsync as used in this way is assumed to be produced by, for example, counting Hsync in the timing signal generation unit 34 in the display timing setting unit 16.

The description above concerns a case in which the coordinate indicating the position of the pixel in the vertical direction is acquired by receiving Hsync from the display timing setting unit 16 and counting Hsync by the counter 48. In a case in which the timing signal generator 34 in the display timing setting unit 16 is provided with a register for storing the raster position of the pixel, the counter value may be read from the register directly. This also eliminates the need for a register for counter reset.

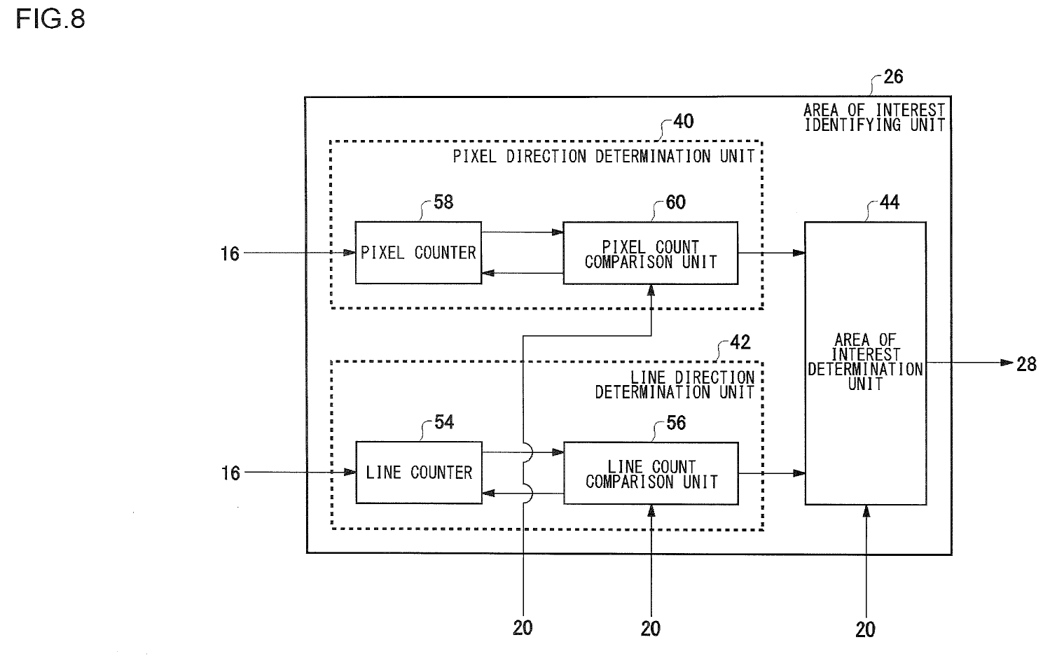

The description above assumes that the line direction determination unit is equipped with a single, integrated function. Alternatively, the line direction determination unit 42 may be considered as being equipped with two functions, i.e., a line counter 54 and a line count comparison unit 56. FIG. 8 shows an example of such a configuration. Like the line direction determination unit 42, the pixel direction determination unit 40 is also provided with a pixel counter 58 and a pixel count comparison unit 60.

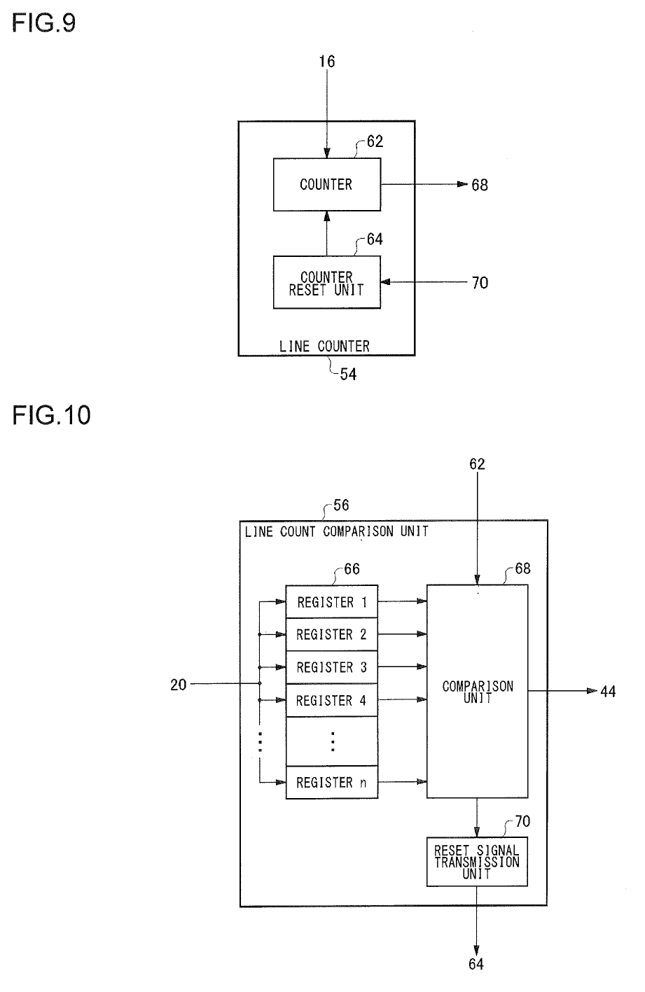

FIG. 9 shows the internal configuration of the line counter 54 of FIG. 8. The line counter 54 includes a counter 62 and a counter reset unit 64. The counter 62 is equipped with a function similar to that of the counter 48. The counter 62 outputs the coordinate indicating the position of the currently read pixel in the vertical direction to the line count comparison unit 56. In order to prevent the counter within the line counter 56 from being saturated, the counter reset unit 64 receives a signal to reset the counter from the line counter comparison unit 56 and resets the counter to “0” accordingly.

FIG. 10 shows the internal configuration of the line count comparison unit 56 of FIG. 8. The line count comparison unit 56 includes a register group 66, a comparison unit 68, and a reset signal transmission unit 70. The register group 66 and the comparison unit 68 are equipped with functions similar to those of the register group 46 and the comparison unit 50, respectively. When the coordinate indicating the position of the pixel received from the counter 62 in the line counter 54 is equal to or greater than the coordinate defining the boundary of the non-display area in the vertical direction stored in register n of the register group 46, the comparison unit 48 requests the reset signal transmission unit 70 to transmit a reset signal to reset the counter. Upon receipt of the request for transmission of a reset signal, the reset signal transmission unit 70 transmits a reset signal to the counter reset unit 64.

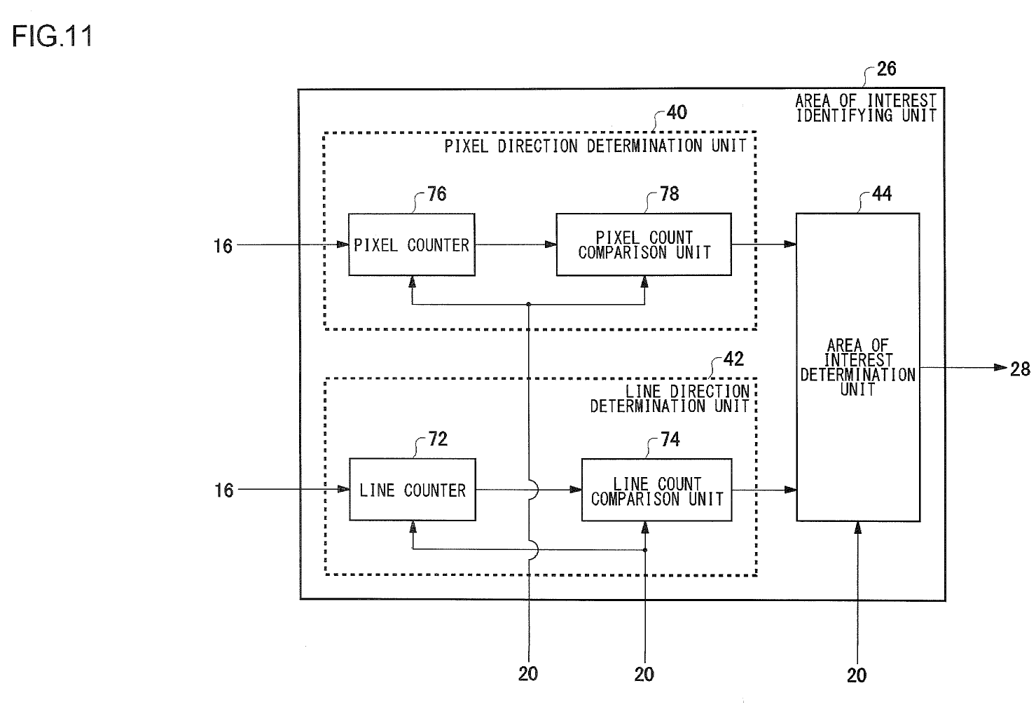

The description above concerns a case in which the line counter comparison unit 56 determines the time to reset the counter in the line counter 54. The timing of resetting the counter may be determined within the line counter unit. FIG. 11 shows an example of such a configuration. In this example, too, the line direction determination unit 42 includes a line counter 72 and a line count comparison unit 74. Similarly, the pixel direction determination unit 40 includes a pixel counter 76 and a pixel count comparison unit 78.

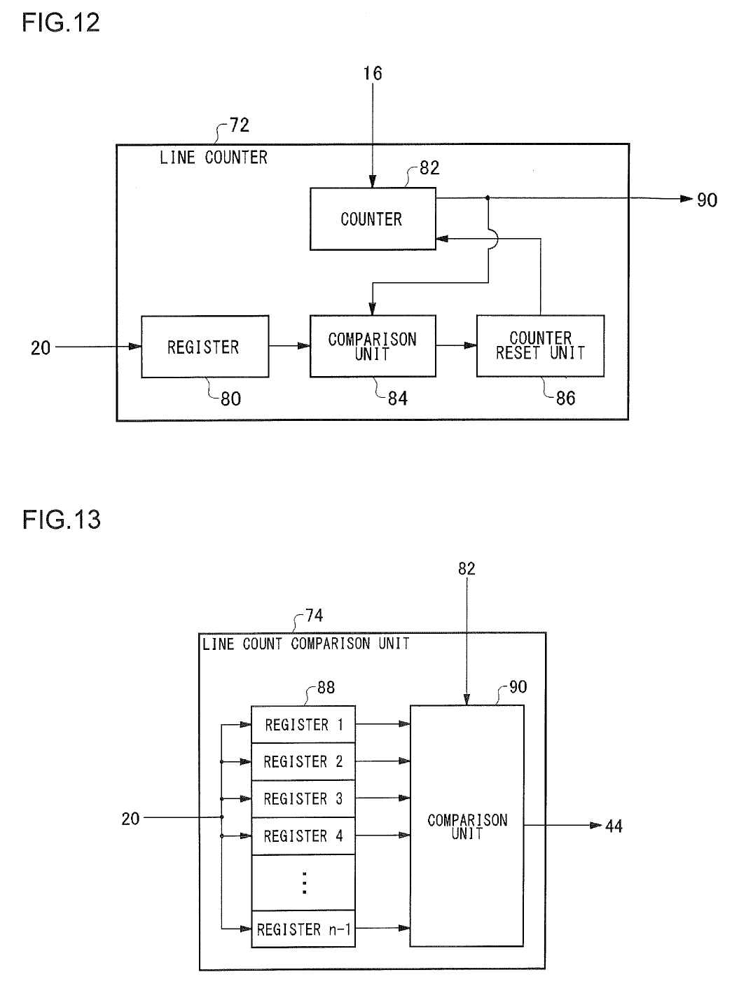

FIG. 12 shows the internal configuration of the line counter 72 of FIG. 11. The line counter 72 includes a register 80, a counter 82, a comparison unit 84, and a counter reset unit 86. The counter 82 acquires the coordinate indicating the position of the currently read pixel in the vertical direction by receiving and counting Hsync from the display timing setting unit 16. The coordinate as acquired is output to a comparison unit 90 in the line count comparison unit 74 described later and also output to the comparison unit 84. The comparison unit 84 acquires the coordinate defining the boundary of the non-display area in the vertical direction from the register 80, which receives the coordinate from the area of interest information input unit and stores the coordinate. The unit 84 then compares the coordinate thus acquired with the coordinate indicating the position of the pixel and acquired from the counter 82. When the coordinate indicating the position of the pixel is equal to or greater than the coordinate of the non-display area in the vertical direction, the comparison unit 84 requests the counter reset unit 86 to reset the counter value in the counter 82 to “0”. The counter reset unit 86 resets the counter value in the counter 82 to “0” in response to the request from the comparison unit 84.

FIG. 13 shows the internal configuration of the line count comparison unit of FIG. 11. The line count comparison unit 74 includes a register group 88 and a comparison unit 90. Unlike the line count comparison unit 56 described above, it is not necessary for the line count comparison unit 74 to determine when to the reset the counter in the line counter. Therefore, the register 88 need not be provided with a register for storing the coordinate of the non-display area in the vertical direction. The comparison unit 90 is equipped with a function similar to that of the unit 50.

Given above is a detailed description of the line direction determination unit 42. The pixel direction determination unit 40 has a configuration substantially similar to that of the line direction determination unit 42. The difference is that the unit 40 receives the pixel clock instead of Hsync and acquires the position of the currently read pixel in the horizontal direction. The pixel direction determination unit 40 receives the coordinate defining the boundary of the area of interest in the horizontal direction and the coordinate defining the boundary of the non-display area in the horizontal direction. The unit 40 stores the coordinates thus received.

As described in relation to the line direction determination unit 42, a synchronization signal may be used to reset the counter in the line direction determination unit. More specifically, the counter may be reset when Hsync, the synchronization signal, is asserted.

The area of interest determination unit 44 according to the embodiment will be described by way of example.

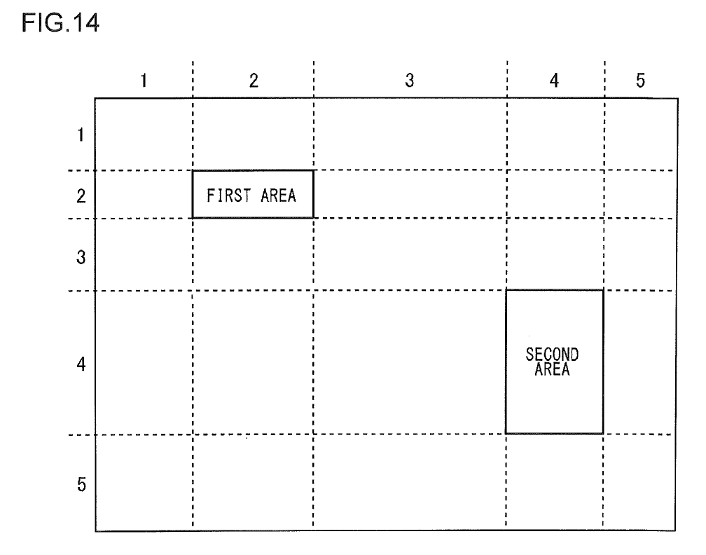

FIG. 14 shows an example where two rectangular areas of interest, i.e., the first area and the second area, are located in the display area. The first area is identified as an area associated with the identifier of 2 in the horizontal direction and the identifier of 2 in the vertical direction. Like the identifier in the vertical direction output by the line direction determination unit, the identifier in the horizontal direction is an identifier output from the pixel direction determination unit 40 to identify the area of interest that includes the currently read pixel in the horizontal direction. The second area is identified as an area associated with the identifier of 4 in the horizontal direction and the identifier of 4 in the vertical direction. FIG. 14 only shows the display area and does not show the non-display area.

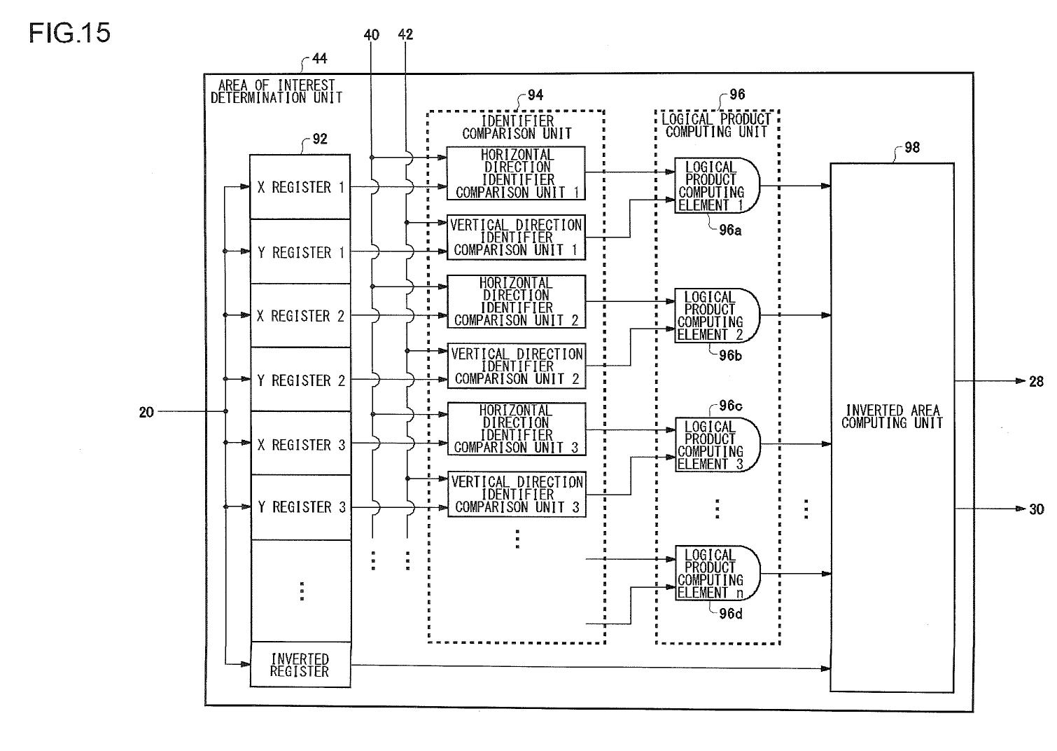

FIG. 15 shows the internal configuration of the area of interest determination unit 44. The area of interest determination unit 44 includes a register group 92, an identifier comparison unit 94, a logical product computing unit 96, and an inverted area computing unit 98. The register group 92 is a part configured to receive information to identify an area of interest from the area of interest information input unit 20 and to store the information. For example, when two rectangular areas of interest, i.e., the first area and the second area, are located in the display area as shown in FIG. 14, the horizontal direction identifier of 2 of the first area is stored in X register 1 in the register group 92. The vertical direction identifier of 2 of the first area is stored in Y register 1 in the register group 92. Similarly, the horizontal direction identifier of 4 of the second area is stored in X register 2, and the vertical direction identifier of 4 is stored in Y register 2. The inverter register is a 1-bit register containing 0 or 1. Thus, the register group 92 includes a total of at least 2n+1 registers, where n denotes the number of areas of interest. The detail of the inverted register will be described later.

The identifier comparison unit 94 compares the identifier stored in the register group 92 and the identifier received from the pixel direction determination unit 40 and the line direction determination unit 42 so as to determine whether the identifiers as compared match. For example, the horizontal direction identifier comparison unit 1 in the identifier comparison unit 94 compares the value 3 stored in register 1 with the value received from the pixel direction determination unit 40. When the values match, the unit 1 outputs “1”. When the values differ, the unit 1 outputs “0”.

The logical product computing unit 96 receives the result of comparing the horizontal direction and vertical direction identifiers for each of the areas of interest, from the identifier comparison unit 94, and computes a logical product thereof. The unit 96 includes at least as many logical product computing elements as the number of areas of interest. For example, the logical product computing element 1 in the logical product computing unit 96 computes a logical product of the results output from the horizontal direction identifier comparison unit 1 and the vertical direction identifier comparison unit 1 in the identifier comparison unit 94. When the currently read pixel is included in the first area of interest, the outputs from the horizontal direction identifier comparison unit 1 and the vertical direction identifier comparison unit 1 are both “1” so that the output from the logical product computing element 1 will be “1”. When the pixel is not included in the first area of interest, one or both of the outputs from the horizontal direction identifier comparison unit 1 and the vertical direction identifier comparison unit 1 will be “0” so that the output from the logical product computing element 1 will be 0. When the output from the logical product computing element 1 corresponding to an area of interest is “1”, it means that the pixel is included in the corresponding area of interest. When the output from the corresponding logical product computing element is “0”, it means that the pixel is not included in the area of interest.

The inverted area computing unit 98 is a part configured to receive the outputs from the logical product computing unit 96, i.e., the information indicating whether the pixel is included in each area of interest and information from the inverted register, so as to determine whether the pixel is included in an area of interest and, if so, in which area the pixel is included. A description will now be given of the operation of the inverted area computing unit 98.

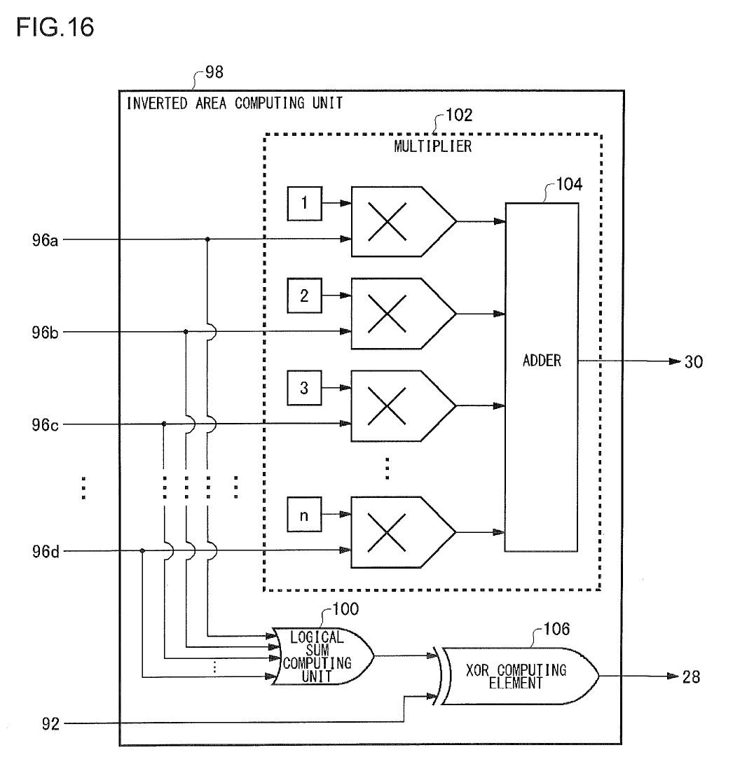

FIG. 16 shows the internal configuration of the inverted area computing unit 98. The inverted area includes a logical sum computing unit 100, a multiplier 102, an adder 104, and an exclusive OR computing element 106. The logical sum computing unit 100 is a part configured to receive the information indicating whether pixel is included in each area of interest from the logical product computing unit 96 and compute a logical sum of the information. In other words, when the pixel is included in any of the areas of interest, the unit 100 outputs “1”. The unit outputs “0” when the pixel is not included in any of the areas of interest.

The multiplier 102 receives the information indicating whether pixel is included in each area of interest from the logical product computing unit 96 and multiplies the information by predetermined constant. The multiplier 102 includes at least as many multiplying elements as the number of areas of interest. In other words, the multiplier 102 includes multiplying elements corresponding to respective areas of interest. It will be assumed that the pixel is included in area of interest 2, given two rectangular areas of interest, i.e., the first area and the second area, located in the display area as shown in FIG. 14. In this case, the value sent from the logical product computing unit 96 (the value sent via 96b) will be “1” and the value corresponding to the area of interest 1 (the value sent via 96a) is “0”. Each of the multiplying elements corresponding to the respective areas of interest multiplies the information inherent to the pixel by the number equal to the serial number of the area of interest. The multiplying element corresponding to the area of interest 1 performs multiplication 0×1, and the multiplying element corresponding to the area of interest 2 performs multiplication 1×2.

The adder 104 is a part configured to compute a total sum of the outputs from the multiplying elements included in the multiplier 102. In this example, the output from the multiplying element corresponding to area of interest 1 is 0, and the output from the multiplying element corresponding to area of interest 2 is 2 so that the adder 104 outputs 2=0+2. Generally, a pixel is not included in multiple areas of interest so that the output from the adder 104 will be equal to the serial number of the area including the pixel. When the pixel is not included in any of the areas of interest, all of the values from the logical product computing unit are “0” so that the output from the adder 104 will be “0”.

Thus, when the pixel is included in any of the areas of interest, the output from the logical sum computing unit 100 will be “1” and the output from the adder 104 represents the serial number of the area of interest including the pixel. When the pixel is not included in any of the areas of interest, the output from the logical sum computing unit 100 and the adder 104 are both “0”.

When the areas of interest are as many rectangular areas in the display area as shown in FIG. 14, the above-described configuration is capable of determining whether the pixel is included in any of the areas of interest. However, an area of interest may be an area of a shape derived from excluding a specified rectangular area within the display area. In order to process such an area of interest, an extra step is necessary in addition to the steps described above. The information in the inverted register is used for that purpose. Specifically, the exclusive OR computing element 106 computes a logical sum of the output from the logical sum computing unit 100 and the value in the inverted register. The element 106 is configured to output “1” when the pixel is included in any of the areas of interest and output “0” when the pixel is not included any of the areas of interest. The detail of such a configuration will be described now.

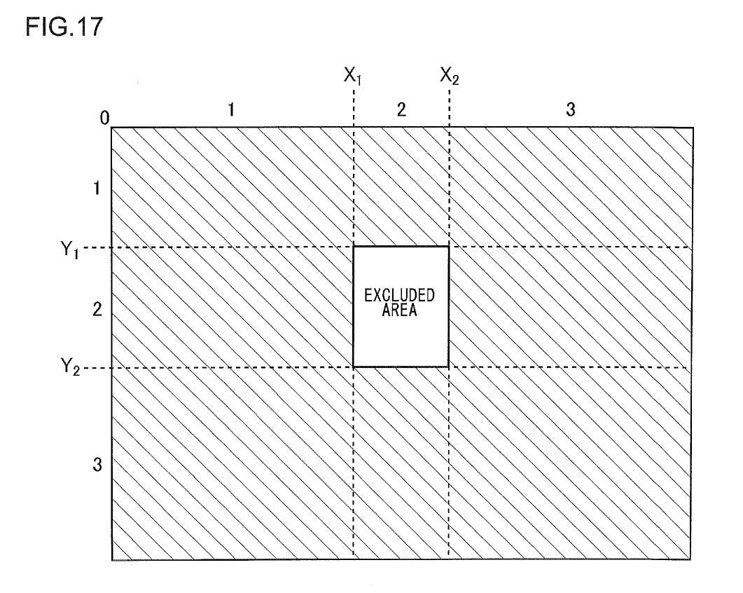

FIG. 17 shows a case in which an area of interest is configured as an area derived from excluding a specified rectangular area within the display area. Specifically, the area of interest is an area derived from excluding the rectangular area defined by X1-X2 in the horizontal direction and Y1-Y2 in the vertical direction. In other words, the area of interest is an area derived from excluding the area with the horizontal direction identifier of 2 and the vertical direction identifier of 2.

Initially, the horizontal direction identifier of 2 for identifying the excluded area is stored in X register 1 in the register group 92 in the area of interest determination unit 44. The vertical direction identifier of 2 is stored in Y register 1. As a result, the output from the logical sum computing unit 100 will be “1” and the output from the adder 104 will be “1” when the pixel is included in the excluded area. When an area of interest is defined by specifying an excluded area as in this case, the area of interest input unit 20 is used to set the value in the inverted register in the register group 92 to “1”. When this is done, the exclusive OR computing element 106 XORs the output “1” from the logical sum computing element 100 and the output “1” from the inverted register so as to output “0”. In other words, it can be determined that the pixel is not included in the area of interest. Meanwhile, when the pixel is not included in the excluded area, the output from the logical sum computing element 100 will be “0” so that the output from the exclusive OR computing element 106 will be “1”. That the pixel is not included in the excluded area means that the pixel is included in the area of interest and so the output of “1” from the exclusive OR computing element 106 properly represents the fact.

When areas of interest are defined as several rectangular areas within the display area as shown in FIG. 14, the value in the inverted register is set to “0”. When this is done, the output from the logical sum computing unit 100 will be “1” when the pixel is included in any of the areas of interest. An XOR of this value and the value “0” of the inverted register will be “1”, which is identical with the output from the logical sum computing unit 100. When the pixel is not included in any of the areas of interest, the output from the logical sum computing unit 100 will be “0”. An XOR of this value and the value “0” of the inverted register will be “0”, which is also identical with the output from the logical sum computing unit 100.

To summarize, irrespective of whether areas of interest are defined as several rectangular areas within the display area as shown in FIG. 14 or an area of interest is defined by specifying an excluded area as shown in FIG. 17, the value from the exclusive OR computing element 106 will be “1” when the pixel is included in the area of interest. Conversely, when the pixel is not included in any of the areas of interest, the value from the exclusive OR computing element 106 will be “0”. Further, when areas of interest are defined as several rectangular areas within the display area as shown in FIG. 14, the adder 104 outputs the serial number of the area of interest including the pixel. When an area of interest is defined by specifying an excluded area as shown in FIG. 17, the output from the adder 104 will be “0”.

A description will now be given of the pixel selection unit 28 in the mapping transformation unit 18. The pixel selection unit 28 receives a pixel read by the pixel reading unit 10. The unit 28 also receives the output from the logical sum computing element 106 in the area of interest identifying unit 26 so as to determine whether the currently read pixel is included in the area of interest. In other words, when the output from the exclusive OR computing element 106 is “1”, it means that the pixel is included in the area of interest so that the unit 28 outputs the pixel to the finite-bit generation unit 30, indicating that the pixel forms an image subject to mapping transformation. When the output from the exclusive OR computing element 106 is “0”, the unit 28 determines that the pixel is not included in the area of interest.

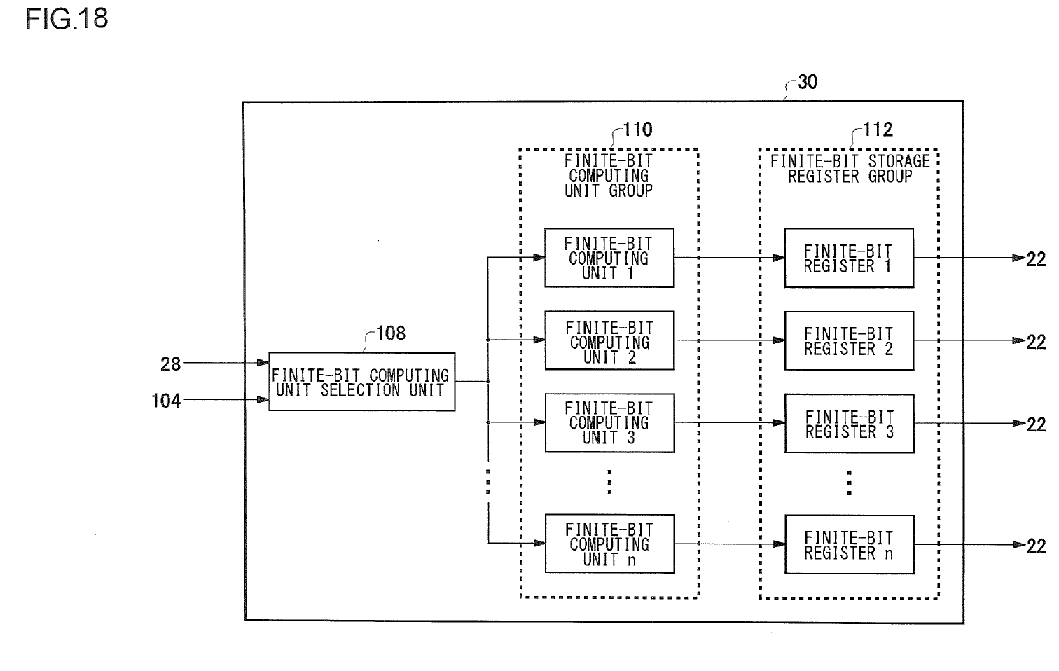

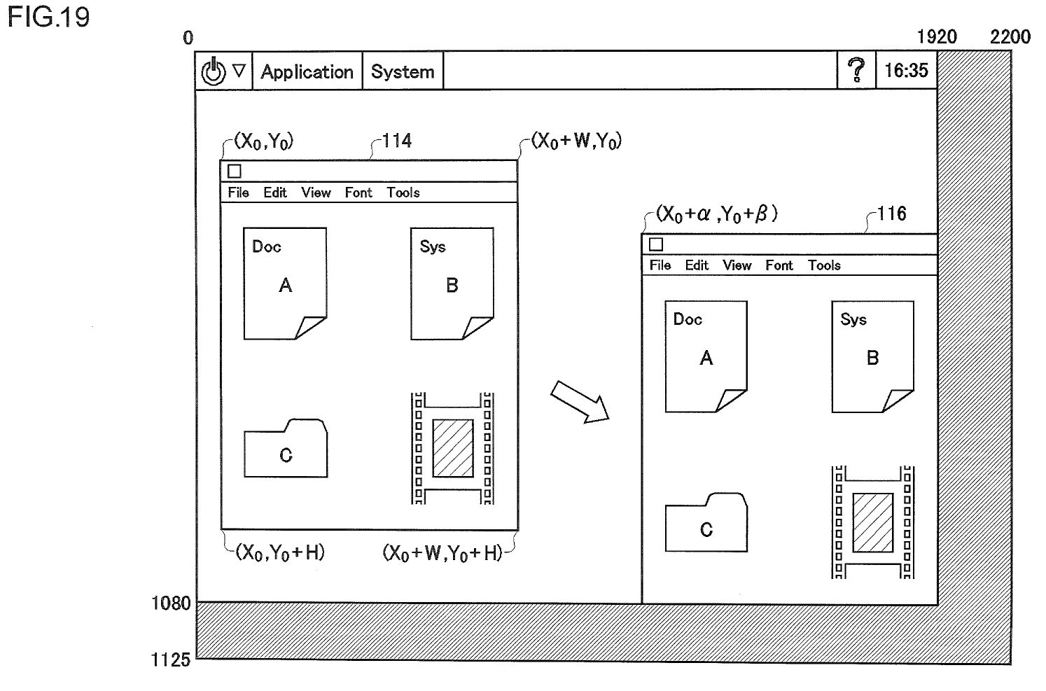

FIG. 18 shows the internal configuration of the finite-bit generation unit 30. The finite-bit generation unit 30 includes a finite-bit computing unit selection unit 108, a finite-bit computing unit group 110, and a finite-bit storage register group 112. The finite-bit computing unit selection unit 108 receives pixel information from the pixel selection unit 28 and receives the number identifying the area of interest including the pixel from the adder 104 in the area of interest identifying unit 26. The finite-bit computing unit selection unit 108 selects a finite-bit computing unit that should compute pixel information based on the number thus received and outputs the pixel information to the selected finite-bit computing unit. For example, when the unit 108 receives information indicating that the pixel is included in the second area of interest, the unit 108 outputs the pixel information to finite-bit computing unit 2 in the finite-bit computing unit group 110.

The finite-bit computing unit group 110 includes at least as many finite-bit computing units as the number of areas of interest. Each finite-bit computing unit subjects the pixel information on the pixel included in the associated area of interest to mapping transformation, converting the pixel information into a finite number of bits. As mentioned before, the term “mapping transformation” refers to mapping from a large volume of data (pixel data for an image) into a finite number of bits. Any mapping scheme capable of generating a hash value (e.g., cyclic redundancy check or message digest algorithm 5 (MD5)) may be used. CRC is advantageous in that it is capable of starting computation even if the entirety of pixel information in the area of interest subject to mapping transformation is not available yet. When CRC is employed, the CRC value may comprise, for example, 32 bits.

The finite-bit storage register group 112 includes at least as many finite-bit storage registers as the number of areas of interest. Each finite-bit storage register stores the finite number of bits obtained by subjecting the pixel information on the pixel included in the associated area of interest to mapping transformation. The finite number of bits thus stored is referred to by the finite-bit comparison unit 22.

When an area of interest is defined by specifying an excluded area as shown in FIG. 17, the number identifying the area of interest will be “0”. In this case, any finite-bit computing unit may be used.

Described above is a flow whereby the mapping transformation unit 18 according to the embodiment subjects an area of interest to mapping transformation to derive a finite number of bits. A description will now be given of an application of the mapping transformation unit 18 according to the embodiment.

A description will now be given of an example in which a window that moves within the display area is tracked so as to detect whether an image in that window undergoes any change. FIG. 19 shows how a rectangular window 114 of a length W in the horizontal direction and a height H in the vertical direction is displayed in the display area. The four coordinates of the rectangular area are (X0, Y0), (X0+W, Y0), (X0, Y0+H), and (X0+W, Y0+H). In this example, it will be assumed that the display area includes 1920 pixels in the horizontal direction and 1080 pixels in the vertical direction, and the area including the non-display area includes 2200 pixels in the horizontal direction and 1125 pixels in the vertical direction. It will also be assumed that the display is controlled by an operating system or an application program and that the operating system or the application program has the knowledge of the coordinates at which the window is displayed and the size of the window.

A description will first be given of a case in which the position and size of the window are fixed. This represents a case in which the area of interest is defined as a single rectangle.

The operating system or the application program sets, via the area of interest information input unit 20, X0 in register 1 in the line direction determination unit 42 and sets X0+W in register 2. Similarly, Y0 is set in register 1 in the pixel direction determination unit 40 and Y0+H is set in register 2. When X0+W exceeds 2200, 2200 is set instead of X0+W. When Y0+H exceeds 1125, 1125 is set instead of Y0+H. Subsequently, the operating system sets, via the area of interest information input unit 20, a horizontal direction identifier in X register 1 in the area of interest determination unit 44 and a vertical direction identifier in Y register 1, the identifiers defining a rectangular area. In this example, the rectangular window is defined by the horizontal direction identifier of 2 and the vertical direction identifier of 2. Therefore, “2” is set in X register 1 in the area of interest determination unit 44 and “2” is set in Y register 1. Since the area of interest is defined by a single rectangle, the value in the inverted register is set to “0”.

In the event that the image within the window as configured above undergoes a change, the value of finite number of bits generated by the finite-bit generation unit 30 will be different before and after the change. By calculating a finite number of bits for each frame and storing the bits in the finite-bit storage unit 24, and by comparing the two sets of finite number of bits for frames occurring before and after the change in the finite-bit comparison unit 22, a change in the image in the window can be detected. Given that only a specific window is required to be transmitted to a remote destination, this can be advantageously used to reduce the time required for transmission and the bandwidth used by transmitting the image within the window only when there is a change in the window. In a related-art approach, any change in the display area as a whole is detected as such. Even when the display position of only a specific window is changed while the image within the window remains unchanged, image information has to be transmitted accordingly. By way of contrast, the method according to the embodiment is advantageously used to reduce the time required for transmission and the bandwidth used.

Even when the position or size of the window is not fixed such that, for example, the display position is changed by the user, any change in the image within the window can be detected by tracking the window that moves within the display area. A description will now be given of how the window is tracked.

As mentioned before, the display of a window is normally controlled by an operating system or an application program. Therefore, the operating system or the application program has the knowledge of the coordinates where the window is displayed and the size of the window. Thus, each time the position of the window is changed by the user, the information on the area of interest may be transmitted to the area of interest information identifying unit 26 via the area of interest information input unit 20, allowing the image within the window to be subjected to mapping transformation. For example, it will be assumed that the window 114 is moved by a distance α in the horizontal direction and β in the vertical direction, as shown in FIG. 19, resulting in a window 116, the coordinates of the four vertices of the window being (X0+α, Y0+β), (X0+α+W, Y0+β), (X0+α, Y0+β+H), (X0+α+W, Y0+β+H). The operating system or the application program may update the values in register 1 and register 2 in the line direction determination unit via the area of interest information input unit 20 so that X0+α is stored in register 1 and X0+α+W is stored in register 2. Similarly, the register values may be updated so that register 1 in the pixel direction determination stores Y0+β, and register 2 stores Y0+β+H.

Conversely, by defining a specified area as an excluded area, changes in an image in a specific area within the display area can be prevented from being detected. This can be advantageously used in applications such as remote desktop. More specifically, when a change that need not be transmitted (e.g. flashing of a cursor within the display area at the source of transmission) is known, the time required for transmission and the bandwidth used can be reduced by preventing changes in the associated part of the image from being transmitted. By using the method described above to exclude a change in the image due to, for example, flashing of a cursor, the cursor flashing and moving may be tracked but removed from the area of interest.

A description will be given of another application in which the method according to the embodiment is used to verify the operation of hardware constituting image processing devices provided between a display buffer and an image output unit.

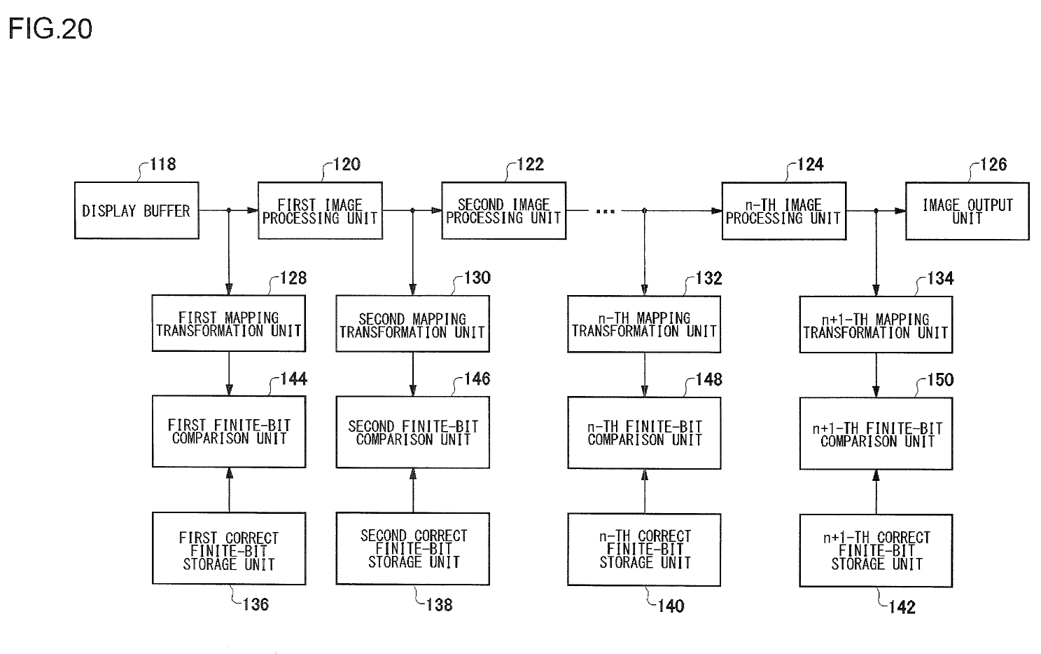

FIG. 20 shows the overall configuration of a graphics processor. FIG. 20 shows how an image stored in the display buffer 118 is processed by a first image processing unit 120, a second image processing unit 122, . . . and an n-th image processing unit 124 before reaching an image output unit 126. Each of the image processing units is responsible for a pipeline process of the graphics processor. For example, each unit performs image processing such as scaling, color space conversion, and dithering which are used to produce an image as output.

A first mapping transformation unit 128 receives image data from the display buffer 118, subjects the area of interest in the image data to mapping transformation and outputs the first finite number of bits. The area of interest may be the whole image. A second mapping transformation unit 130 receives the result of image processing by the first image processing unit 120, subjects the area of interest in the resultant image to mapping transformation, and outputs the second finite number of bits. Likewise, an n-th mapping transformation unit 132 generates a finite number of bits from the result of image processing by the n−1 image processing unit, and an n+1-th mapping transformation unit generates a finite number of bits representing the area of interest in the image resulting from the image processing by the n-th image processing unit.

The result that should be output from the image processing unit is computed in advance using, for example, computer simulation. The finite number of bits are computed for each area of interest. The finite number of bits thus computed are stored in a correct finite-bit storage unit as correct finite number of bits. More specifically, the correct finite number of bits for the area of interest in the image data stored in the display buffer are stored in a first correct finite-bit storage unit 136. The correct finite number of bits for the area of interest in the image resulting from the image processing by the first image processing unit 120 are stored in a second correct finite-bit storage unit 138. Likewise, the correct finite number of bits for the area of interest in the image resulting from the image processing by the n−1-th image processing unit are stored in an n-th correct finite-bit storage unit 140. The correct finite number of bits for the area of interest in the image resulting from the image processing by the n-th image processing unit are stored in an n+1-th correct finite-bit storage unit 142.

By comparing the finite number of bits obtained in each mapping transformation unit with the associated correct finite number of bits, the operation of a series of image processing units can be verified. More specifically, the first finite-bit comparison unit 144 compares the finite number of bits computed by the first mapping transformation unit 128 with the finite number of bits stored in the first correct finite-bit storage unit 136. When the two sets of bits as compared match, it is verified that transfer of information from the display buffer 118 to the first mapping transformation unit 128 is not in error. The second finite-bit comparison unit 146 compares the finite number of bits computed by the second mapping transformation unit 130 with the finite number of bits stored in the second correct finite-bit storage unit 138. When the two sets of bits as compared match, it is verified that the first image processing unit is operated properly. When it is verified by the n-th finite-bit comparison unit 148 that the n−1-th image processing unit is operated properly and when the n+1-th finite-bit comparison unit 150 determines that the operation of the n-th image processing unit is in error, it can be identified that a trouble in image processing occurs in the n-th image processing unit.

Generally, when image processing is performed serially using a pipeline process as shown in FIG. 20, an error occurring in an image processing unit upstream is inherited by the result of image processing downstream. Therefore, the identity of the image processing unit in trouble can be determined by verifying the operation before and after image processing in each image processing unit. This make available information useful to identify a trouble in hardware constituting each image processing unit.

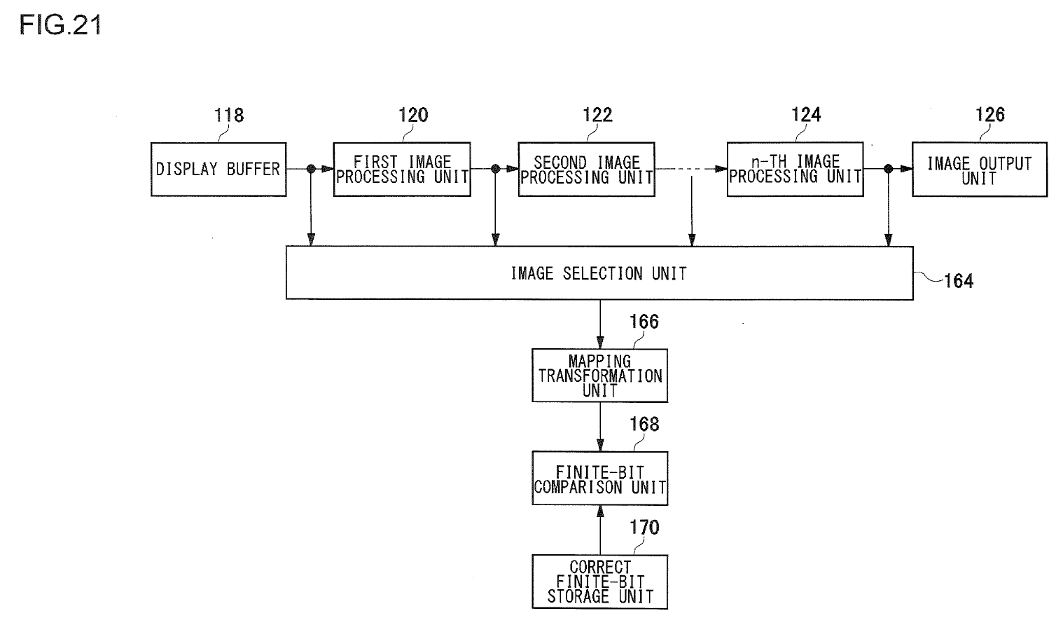

FIG. 21 shows another example of the overall configuration of a graphics processor. FIG. 21 shows an example in which the information is processed through multiple image processing units provided between a display buffer and an image output unit, and the information is subject to mapping transformation preceding and following image processing in each image processing unit. As in the example shown in FIG. 20, the image stored in the display buffer 118 is processed by the first image processing unit 120, the second image processing unit 122, . . . and the n-th image processing unit 124 before reaching the image output unit 126.

An image selection unit 164 is a part configured to acquire a result of image processing in the middle of the path between the display buffer 118 and the image output unit 126. Since there are multiple image processing units, there are multiple results of image processing, and so the image selection unit 164 selects and acquires a desired result of image processing. For example, when the result of image processing by the first image processing unit 120 is to be acquired, the image is acquired between the first image processing unit 120 and the second image processing unit 122.

A correct finite-bit storage unit 170 is a part configured to store correct finite number of bits computed from an image that should be output to the image selection unit 164 upon selection and acquisition by the unit 164 and that is generated using computer simulation or the like. By using a finite-bit comparison unit 168 to compare the correct finite number of bits with the image acquired by the image selection unit 164 and transformed by the mapping transformation unit 166, the operation of the image processing unit selected by the image selection unit 164 is verified. Provision of the image selection unit 164 advantageously reduces the number of mapping transformation units, finite-bit comparison units, and correct finite-bit storage units.

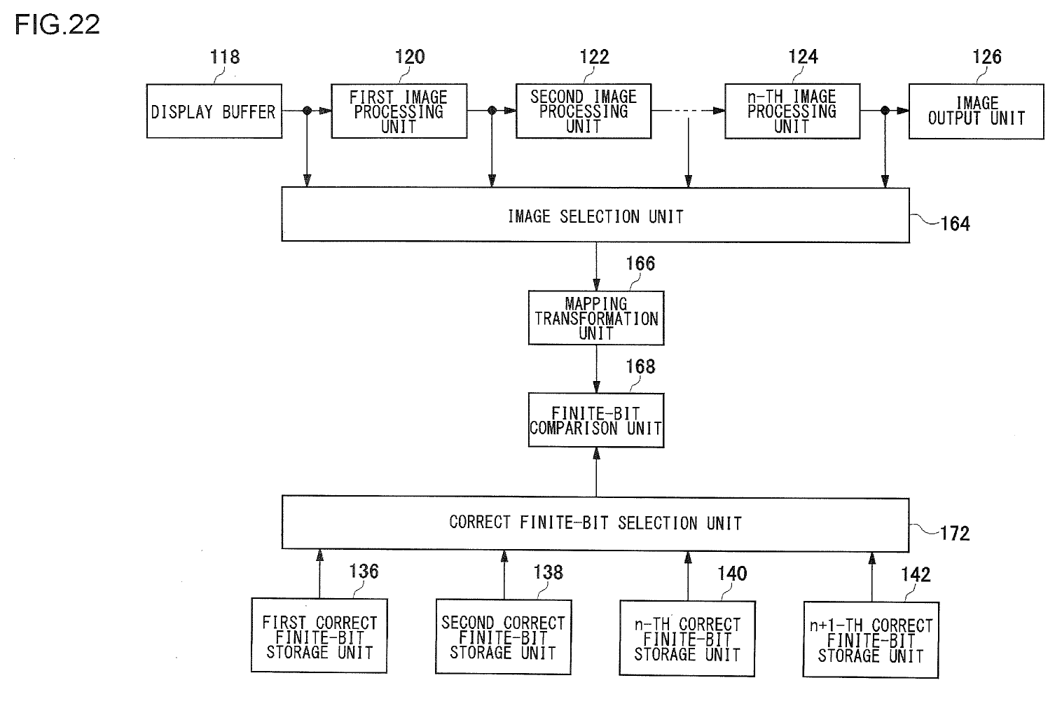

FIG. 22 shows another example of the overall configuration of a graphics processor. FIG. 21 shows an example in which the information is processed through multiple image processing units provided between a display buffer and an image output unit, and the information is subject to mapping transformation preceding and following image processing in each image processing unit. As in the examples shown in FIGS. 20 and 21, the image stored in the display buffer 118 is processed by the first image processing unit 120, the second image processing unit 122, . . . and the n-th image processing unit 124 before reaching the image output unit 126. As in the example shown in FIG. 20, the graphics processor is provided with multiple correct finite-bit storage units including the first correct finite-bit storage unit 136, the second correct finite-bit storage unit 138, . . . the n-th correct finite-bit storage unit 140, and the n+1-th correct finite-bit storage unit 142. As in the example shown in FIG. 21, the graphics processor is provided with the image selection unit 164, the mapping transformation unit 166, and the finite-bit comparison unit 168.

The correct finite-bit selection unit 172 is a part configured to select an arbitrary set of correct finite number of bits from the multiple sets of correct finite number of bits stored in the correct finite-bit storage unit. For example, in association with the acquisition by the image selection unit 164 of the result of image processing by the first image processing unit 120, the unit 172 acquires the correct finite number of bits from the second correct finite-bit storage unit 138, which stores the finite number of bits obtained by subjecting the image that should be output from the first image processing unit 120 to mapping transformation. By using the finite-bit comparison unit 168 to compare the correct finite number of bits with the image acquired by the image selection unit 164 and transformed by the mapping transformation unit 166, the operation of the image processing unit selected by the image selection unit 164 is verified. The provision is advantageous when there are multiple sets of finite number of bits, obtained by subjecting images that should be output from multiple image processing units to mapping transformation, are available because the operation of each image processing unit can be verified easily by changing the target of selection by the image selection unit 164 and the correct finite-bit selection unit 172.

It is assumed that each mapping transformation unit is externally supplied with the pixel count and Hsync, which are necessary for computation for mapping transformation, and with information for identifying an area of interest. Moreover, the target of selection by the image selection unit 164 and the correct finite-bit selection unit 172 can be changed as desired via an input unit (not shown) in response to user action or initiated by an operating system or an application program.

Described above is a configuration for identifying one of multiple image processing units that is in trouble. The mapping transformation unit according to the embodiment can also be used to detect a defective area in an mage output from the image processing unit identified as being in trouble. A description will now be given of this application.

In a case in which an image processing unit is adapted to change a particular hue of a pixel forming an image, a selected area in the image is changed. A specific example of such a process is one whereby the background color of an image is replaced. In this case, the correct finite number of bits for the entire image are compared with the finite number of bits computed from the result of image processing. When the two sets of bits do not match, then a comparison between the correct finite number of bits and the finite number of bits computed from the result of image processing is made only for the right half of the image. When the two sets of bits match, it can be determined that the trouble occurring in the image processing unit is associated with the left half of the image. By successively narrowing down the image area subject to comparison, search for the area in which the trouble occurs as a result of image processing by the image processing unit is refined accordingly. The area in trouble can be ultimately identified.

Described above is an explanation based on an exemplary embodiment. The embodiment is intended to be illustrative only and it will be obvious to those skilled in the art that various modifications to constituting elements and processes could be developed and that such modifications are also within the scope of the present invention.

The area of interest identifying unit 26 and the pixel selection unit 28 as described above can be implemented by software using a microcomputer or the like. The pixel counters 58 and 76, and the line counters 54 and 72 in the area of interest identifying unit 26 can be implemented by hardware and the rest may be implemented by software using a microcomputer or the like. The area of interest identifying unit 26 can be implemented by simple logic operations and using comparators. Therefore, the entirety of the unit 26 may be implemented by hardware. In this process, the comparison unit can be shared so that, as shown in FIG. 6, it is desirable that the line counter and the line count comparison unit be implemented as a single, integrated hardware unit and that the pixel counter and the pixel count comparison unit be implemented as a single, integrated hardware unit. Further, since the area of interest determination unit 44 can be implemented by a simple circuit, implementation of the area of interest identifying unit 26 as a single hardware block is more advantageous because of reduced cost.

What is claimed is:

1. An image processing device comprising:
a display timing setting unit adapted to determine the timing of rendering an image by raster scanning;
a pixel reading unit adapted to read a pixel according to timing information output from the display timing setting unit;
an area of interest information input unit adapted to enter information for identifying an arbitrary area of interest within an image;
an area of interest identifying unit adapted to determine whether the pixel is included in the area of interest based on the timing information output by the display timing setting unit; and
a finite-bit generation unit adapted to generate a finite bit series by subjecting information on the pixel to mapping transformation when the pixel is included in the area of interest.

2. The image processing device according to claim 1, wherein
the area of interest identifying unit counts a horizontal synchronization signal and a pixel clock received from the display timing setting unit and determines whether the pixel is included in the area of interest based on a count value.

3. The image processing device according to claim 1, further comprising:
a finite-bit comparison unit adapted to compare a first finite bit series generated by the finite-bit generation unit and a second finite bit series computed in advance and stored so as to determine whether an image used to generate the first finite bit series is different from an image used to generate the second finite bit series.

4. The image processing device according to claim 3, wherein
the image used to generate the second finite bit series is from a frame occurring in the past with respect to the image used to generate the first finite bit series.

5. The image processing device according to claim 3, further comprising:
a display buffer adapted to store image information; and
an image processing unit adapted to transform the image, wherein
the image used to generate the first finite bit series is the image actually output by the image processing unit, and the image used to generate the second finite bit series is the image that should be output from the image processing unit.

6. An image processing device comprising:
a display buffer adapted to store image information;
a plurality of image processing units adapted to transform the image information and connected in series;
a finite-bit generation unit adapted to generate a first finite bit series by subjecting an image actually output by each image processing unit to mapping transformation; and
a finite-bit comparison unit adapted to verify the operation of each image processing unit by comparing a second finite bit series obtained by subjecting an image that should be output from each image processing unit to mapping transformation with the first finite bit series.

7. An image processing method comprising:
determining the timing of rendering an image by raster scanning;
reading a pixel according to timing information output from a display timing setting unit;
entering information for identifying an arbitrary area of interest within an image;
determining whether the pixel is included in the area of interest based on the timing information output by the display timing setting unit; and
generating a finite bit series by subjecting information on the pixel to mapping transformation when the pixel is included in the area of interest.

8. A computer program embedded in a computer readable recording medium, comprising:
a module adapted to determine the timing of rendering an image by raster scanning;
a module adapted to read a pixel according to timing information output from the display timing setting unit;
a module adapted to enter information for identifying an arbitrary area of interest within an image;
a module adapted to determine whether the pixel is included in the area of interest based on the timing information output by the display timing setting unit; and
a module adapted to generate a finite bit series by subjecting information on the pixel to mapping transformation when the pixel is included in the area of interest.
